(19) United States
(12) Patent Application Publication
(10) Pub. No.: US 2024/0397603 A1
(43) Pub. Date: Nov. 28, 2024

(54) OPTICAL MODULE FOR EXTREME ULTRAVIOLET LIGHT SOURCE

(71) Applicant: ASML Netherlands B.V., Veldhoven (NL)

(72) Inventors: Erik Fernando Huerta, Carlsbad, CA (US); Jaden Robert Bankhead, San Diego, CA (US); Moonseob Jin, San Diego, CA (US); Paul Alexander McKenzie, San Diego, CA (US)

(21) Appl. No.: 18/690,873

(22) PCT Filed: Sep. 1, 2022
(86) PCT No.: PCT/EP2022/074381

§ 371 Date: Mar. 11, 2024

Related U.S. Application Data
(60) Provisional application No. 63/245,999, filed on Sep. 20, 2021.

(51) Int. Cl. H05G 2/00; G02B 3/06; G02B 13/18; G02B 19/00

(52) U.S. Cl. CPC H05G 2/008; G02B 3/06; G02B 13/18; G02B 19/0047

(57) ABSTRACT

An optical module is configured to pass an optical beam. The optical module includes: a plurality of lenses through which the optical beam passes, the plurality of lenses including at least one aspheric toroid lens; and an optical mount apparatus in which the plurality of lenses is mounted. The plurality of lenses is placed relative to a linearly focused curtain of the optical beam, the linearly focused curtain intersecting a region of interest. The optical mount apparatus is arranged in or fixed to a wall of a chamber of an extreme ultraviolet (EUV) light source such that an optical path is defined that passes through the EUV light source chamber and intersects the region of interest inside the chamber.

### CROSS REFERENCE TO RELATED APPLICATIONS

This application claims priority to U.S. Application No. 63/245,999, filed Sep. 20, 2021, titled OPTICAL MODULE FOR EXTREME ULTRAVIOLET LIGHT SOURCE, which is incorporated herein in its entirety by reference.

### TECHNICAL FIELD

The disclosed subject matter relates to an optical module for passing an optical beam into or out of a chamber of an extreme ultraviolet (EUV) light source.

### BACKGROUND

Extreme ultraviolet (EUV) light, for example, electromagnetic radiation having wavelengths of around 50 nm or less (also sometimes referred to as soft x-rays), and including light at a wavelength of about 13 nm, can be used in photolithography processes to produce extremely small features in substrates, for example, silicon wafers.

Methods to produce EUV light include, but are not necessarily limited to, converting a material that has an element, for example, xenon, lithium, or tin, with an emission line in the EUV range in a plasma state. In one such method, often termed laser produced plasma (“LPP”), the required plasma can be produced by irradiating a target material, for example, in the form of a droplet, plate, tape, stream, or cluster of material, with an amplified light beam that can be referred to as a drive laser. For this process, the plasma is typically produced in a sealed vessel, for example, a vacuum chamber, and monitored using various types of metrology equipment.

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is interchangeably referred to as a mask or a reticle, can be used to generate a circuit pattern to be formed on an individual layer of the IC being formed. This pattern can be transferred onto a target portion (e.g., including part of, one, or several dies) on a substrate (e.g., a silicon wafer). Transfer of the pattern is typically via imaging onto a layer of radiation-sensitive material (e.g., resist) provided on the substrate. In general, a single substrate will contain a network of adjacent target portions that are successively patterned. Traditional lithographic apparatuses include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the target portions parallel or anti-parallel to this scanning direction. It is also possible to transfer the pattern from the patterning device to the substrate by imprinting the pattern onto the substrate.

Extreme ultraviolet (EUV) light, for example, electromagnetic radiation having wavelengths of around 50 nanometers (nm) or less (also sometimes referred to as soft x-rays), and including light at a wavelength of about 13 nm, can be used in or with a lithographic apparatus to produce extremely small features in substrates, for example, silicon wafers. Methods to produce EUV light include, but are not necessarily limited to, converting a material that has an element, for example, xenon (Xe), lithium (Li), or tin (Sn), with an emission line in the EUV range to a plasma state. For example, in one such method called laser produced plasma (LPP), the plasma can be produced by irradiating a target material, which is interchangeably referred to as fuel in the context of LPP sources, for example, in the form of a droplet, plate, tape, stream, or cluster of material, with an amplified light beam that can be referred to as a drive laser. For this process, the plasma is typically produced in a sealed vessel, for example, a vacuum chamber, and monitored using various types of metrology equipment.

### SUMMARY

In some general aspects, an optical module is configured to pass an optical beam. The optical module includes: a plurality of lenses through which the optical beam passes, the plurality of lenses including at least one aspheric toroid lens; and an optical mount apparatus in which the plurality of lenses is mounted. The plurality of lenses is placed relative to a linearly focused curtain of the optical beam, the linearly focused curtain intersecting a region of interest. The optical mount apparatus is arranged in or fixed to a wall of a chamber of an extreme ultraviolet (EUV) light source such that an optical path is defined that passes through the EUV light source chamber and intersects the region of interest inside the chamber.

Implementations can include one or more of the following features. For example, the plurality of lenses can include at least one toroid lens. The at least one toroid lens can include a first plano-concave cylindrical lens and a second plano-concave cylindrical lens. The at least one aspheric toroid lens can be a single lens that is plano-convex, plano-concave, meniscus with one face being aspheric toroid, or meniscus with both faces being aspheric toroid. The second plano-concave cylindrical lens and the aspheric toroid lens can be fixed in position relative to each other and moveable together relative to the first plano-concave cylindrical lens. Adjustment of the first plano-concave cylindrical lens relative to the second plano-concave cylindrical lens and the aspheric toroid lens can thereby adjust a position and/or a width of the linearly focused curtain. The linearly focused curtain of the optical beam can be focused along an axis of the chamber; The first plano-concave cylindrical lens can have a radius of curvature along the axis that is −19 mm to −25 mm. The second plano-concave cylindrical lens can have a radius of curvature along the axis that is −31 mm to −39 mm. The aspheric toroid lens can have a base radius of curvature along the axis that is −26 mm to −32 mm. The distance from an adjacent mechanical output face and an outer face of the aspheric toroid lens can be less than 80 millimeters (mm), less than 70 mm, less than 60 mm, or less than 50 mm. The adjacent mechanical output face can be an output face of an optical collimator The linearly focused curtain can be formed from the optical beam passing through the plurality of lenses and to the region of interest inside the chamber. The aspheric toroid lens can be the lens that is closest to the region of interest. The at least one aspheric toroid lens can be a single lens that is plano-convex, plano-concave, meniscus with one face being aspheric toroid, or meniscus with both faces being aspheric toroid. The aspheric toroid lens can be an acylindrical lens. The plurality of lenses can be configured and arranged to thereby reduce optical aberrations such that their actual resolution is diffraction limited. The optical beam can travel along an optical axis of the chamber, and the linearly focused curtain of the optical beam can have a beam profile along a first axis perpendicular to the optical axis of the chamber that is at least 10, at least 20, at least 30, at least 40, at least 50, or at least 60 times a beam profile along the a second axis perpendicular to the optical of the chamber within the region of interest inside the chamber. The optical mount apparatus can be arranged in a wall of the EUV light source chamber. The optical path can pass through an optically-transparent window fixed within the chamber wall.

In other general aspects, an illumination module is configured for an extreme ultraviolet (EUV) light source. The illumination module includes: a light source configured to produce an optical beam; and an optical module configured to pass the optical beam through a wall of or within a chamber of the EUV light source and to focus the optical beam as a linear curtain at a region of interest inside the chamber. The optical module includes a plurality of lenses through which the optical beam passes and defining an optical path from the light source to the region of interest, the plurality of lenses including at least one aspheric toroid lens.

Implementations can include one or more of the following features. For example, the plurality of lenses can include at least one toroid lens. The at least one toroid lens can include a first plano-concave cylindrical lens and a second plano-concave cylindrical lens. The at least one aspheric toroid lens can be a single lens that is plano-convex, plano-concave, meniscus with one face being aspheric toroid, or meniscus with both faces being aspheric toroid. The second plano-concave cylindrical lens and the aspheric toroid lens can be fixed in position relative to each other and moveable together relative to the first plano-concave cylindrical lens. Adjustment of the first plano-concave cylindrical lens relative to the second plano-concave cylindrical lens and the aspheric toroid lens can thereby adjust a position and/or a width of the linearly focused curtain in the region of the interest. The optical module can have a focus sensitivity of at least 1 μm, at least 10 μm, at least 20 μm, at least 30 μm, or between 32-44 μm per adjustment of the first plano-concave cylindrical lens relative to the second plano-concave cylindrical lens and the aspheric toroid lens of 1 μm. The optical module can have a focus sensitivity that is sensitive enough to allow the optical beam to be focused as the linear curtain at the region of interest inside the chamber using an adjustment range on the order of a micron.

The linearly focused curtain of the optical beam can be focused along an axis of the chamber. The first plano-concave cylindrical lens can have a radius of curvature along the axis that is −19 mm to −25 mm. The second plano-concave cylindrical lens can have a radius of curvature along the axis that is −31 mm to −39 mm. The aspheric toroid lens can have a base radius of curvature along the axis that is −26 mm-−32 mm. The distance from an adjacent mechanical output face and an outer face of the aspheric toroid lens can be less than 80 millimeters (mm), less than 70 mm, less than 60 mm, or less than 50 mm. The adjacent mechanical output face can be an output face of an optical collimator. The aspheric toroid lens can be the lens that is closest to the region of interest. The aspheric toroid lens can be an acylindrical lens. The optical beam can travel along an optical axis of the chamber, and the linearly focused curtain of the optical beam can have a beam profile along a first axis perpendicular to the optical axis of the chamber that is at least 10, at least 20, at least 30, at least 40, at least 50, or at least 60 times a beam profile along a second axis perpendicular to the optical axis of the chamber within the region of interest inside the chamber. The optical beam can be a continuous wave light beam. Each of the lenses can be made of fused silica, optical glass, optical ceramic, or optical crystals.

In other general aspects, an extreme ultraviolet (EUV) light source includes: a chamber including a plurality of walls that together define a cavity, and a region of interest is defined inside the cavity; and an optical module for passing an optical beam. The optical module includes: a plurality of lenses through which the optical beam passes, the plurality of lenses including at least one aspheric toroid lens; and an optical mount apparatus in which the plurality of lenses is mounted. The plurality of lenses is placed relative to a linearly focused curtain of the optical beam, the linearly focused curtain intersecting a region of interest. The optical mount apparatus is arranged in or fixed to a wall of a chamber such that an optical path is defined that intersects the region of interest inside the chamber.

Implementations can include one or more of the following features. For example, plurality of lenses can include at least one toroid lens. The EUV light source can further include an illumination module including a light source configured to produce the optical beam and the optical module configured to receive the produced optical beam from the light source.

### DESCRIPTION OF DRAWINGS

FIG. 1 is a schematic diagram of an optical module arranged relative to a chamber of an extreme ultraviolet (EUV) light source, the optical module including a plurality of lenses that includes at least one aspheric toroid lens having an aspheric toroid surface;

FIG. 2 is a schematic diagram of an implementation of the optical module of FIG. 1 that is a part of an illumination module for the EUV light source chamber;

FIG. 3 is a schematic diagram of an implementation of the optical module and the illumination module of FIG. 2, the optical module including a chamber mount portion that houses an optical mount apparatus in which the lens plurality is arranged, the chamber mount portion being fixed within a wall of the EUV light source chamber;

FIG. 4 is a perspective side view of an implementation of the optical module and illumination module of FIG. 3;

FIG. 5 is a side cross-sectional view of the optical module of FIG. 4, along with a fiber collimator lens assembly and windows;

FIG. 6A is a side perspective view of a first toroid lens of the optical module of FIGS. 4 and 5, in which the first toroid lens is a plano-concave cylindrical lens;

FIG. 6B is a side cross-sectional view of the toroid lens of FIG. 6A taken along the Y_{L}Z_{L} plane;

FIG. 6C is a side cross-sectional view of the toroid lens of FIG. 6A taken along the X_{L}Y_{L} plane;

FIG. 7A is a side perspective view of a second toroid lens of the optical module of FIGS. 4 and 5, in which the second toroid lens is a plano-concave cylindrical lens;

FIG. 7B is a side cross-sectional view of the toroid lens of FIG. 7A taken along the Y_{L}Z_{L} plane;

FIG. 7C is a side cross-sectional view of the toroid lens of FIG. 7A taken along the X_{L}Y_{L} plane;

FIG. 8A is a side perspective view of an aspheric toroid lens of the optical module of FIGS. 4 and 5, in which the aspheric toroid lens is a single lens that is plano-convex;

FIG. 8B is a side cross-sectional view of the aspheric toroid lens of FIG. 8A taken along the Y_{L}Z_{L} plane;

FIG. 8C is a side cross-sectional view of the aspheric toroid lens of FIG. 8A taken along the X_{L}Y_{L} plane;

FIG. 9A is a side plan view of the lens plurality of FIGS. 4 and 5 including the windows taken along the Z axis view that shows a position PY along the Y axis and/or a width WX along the X axis of the linearly focused curtain of an optical beam passed through the lens plurality and traveling to a region of interest;

FIG. 9B is a side plan view of the lens plurality of FIGS. 4 and 5 including the windows taken along the X axis view that shows a position PY along the Y axis and/or a width WZ along the Z axis of the linearly focused curtain of the optical beam passed through the lens plurality and traveling to the region of interest;

FIG. 10A is a beam profile BP of the optical beam of FIGS. 9A and 9B in which the optical beam has an extent parallel with the Z axis that is much larger than an extent parallel with the X axis of the EUV light source chamber, in which the beam profile BP extends or lies in the XZ plane of the EUV light source chamber;

FIG. 10B is a graph of irradiance versus distance along a direction parallel with the Z axis of the EUV light source chamber of the optical beam of FIG. 10A;

FIG. 10C is a graph of irradiance versus distance along a direction parallel with the X axis of the EUV light source chamber of the optical beam of FIG. 10A; and

FIG. 11 is an implementation of the optical module of FIG. 1 that is incorporated into an EUV light source that, when in operation, supplies an EUV light beam to an output apparatus, which can be a lithography exposure apparatus.

### DESCRIPTION

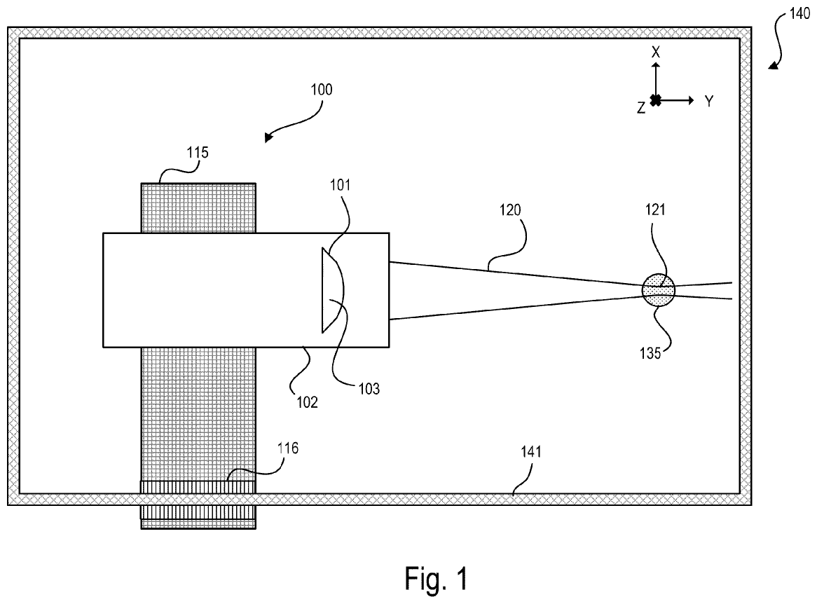

Referring to FIG. 1, an optical module 100 is arranged relative to a chamber 140 of an extreme ultraviolet (EUV) light source. The optical module 100 is configured to pass an optical beam 120 such that the optical beam 120 is focused to a region of interest 135. Space is limited for components within or affixed to the EUV light source chamber 140. Thus, there is a benefit to reducing the size of components that are used in conjunction with the EUV light source chamber 140, and specifically those components that are within or affixed to the EUV light source chamber 140. With this in mind, the optical module 100 is designed with a significant reduction in its overall length relative to prior optical designs that pass the optical beam 120 such that the optical beam 120 is focused to the region of interest 135. Moreover, the optical module 100 does not include additional powered optical elements such as lenses to achieve the significant reduction (for example, a 30% reduction, a 40% reduction, or a 50% reduction) in its overall length. Thus, the optical module 100 provides a more cost-effective solution than one that adds one or more powered optical elements. And, even though the overall length of the optical module 100 is reduced relative to prior optical designs, the optical module 100 maintains its diffraction-limited optical performance. In particular, as discussed in detail below, the optical module 100 is able to achieve the significant reduction in its overall length by replacing at least one of its existing toroid surfaces with an aspheric toroid surface 101.

A toroid surface is a surface that has different radii of curvature in the perpendicular transverse axes. The perpendicular transverse axes are the axes that are transverse to the optical path through the toroid surface. Thus, for example, a toroid surface can be a cylindrical surface, in which the radius of curvature in a first transverse axis is infinite (the curvature is 0) and the radius of curvature in a second transverse axis is finite (and the curvature can be spheric). An aspheric toroid surface (such as the aspheric toroid surface 101) is a toroid surface in which the curvature along one of the transverse axes is non-spherical or aspheric. In this example, the optical path of the aspheric toroid surface 101 aligns or is parallel with a Y axis of the drawing. Thus, the perpendicular transverse axes of the aspheric toroid surface 101 are in the XZ plane of the drawing. Moreover, the optical path of the aspheric toroid surface 101 is aligned with and parallel with the overall optical path of the lens plurality 102.

In some implementations, the optical module 100 is a part of a target metrology apparatus that detects, measures and/or analyzes one or more moving properties (such as speed, velocity, and acceleration) of a target as the target travels generally along the —X direction (but also possibly along the Z or Y directions) through the region of interest 135 on its way toward an illumination space. The optical module 100 can be a part of an illumination module of the target metrology apparatus and the optical beam 120 can be a probing light beam.

The optical module 100 includes a plurality 102 of lenses through which the optical beam 120 passes. The lens plurality 102 includes at least one aspheric toroid lens 103, the aspheric toroid surface 101 being one of the optically-interacting surfaces of the aspheric toroid lens 103. The lens plurality 102 is placed relative to the linearly focused curtain 121 of the optical beam, such curtain 121 intersecting or overlapping the region of interest 135. Because of the aspheric toroid lens 103, the lens plurality 102 is configured and arranged relative to the region of interest 135 to thereby reduce optical aberrations such that the actual resolution is diffraction limited. Optical aberrations arise from interactions between the optical beam 120 and the physical size/shape and material of the lenses within the plurality 102. The aberration-reducing characteristics of the aspheric toroid lens 103 enables the achievement of the diffraction limited performance despite the reduction in overall length of the optical module 100.

The optical module 100 also includes an optical mount apparatus 115 in which the lens plurality 102 is mounted. In some implementations, the optical mount apparatus 115 is arranged inside the EUV light source chamber 140 and fixed to an interior wall or object. In other implementations, as shown in FIG. 1, the optical mount apparatus 115 is fixed to a wall 141 of the EUV light source chamber 140. In these implementations, the optical mount apparatus 115 includes a chamber mount portion 116 configured to be fixed to the wall 141.

The lenses within the lens plurality 102 (including the aspheric toroid lens 103) are made of a material that is transparent to (and therefore has a high transmission for) the wavelength of the optical beam 120. Additionally, the lenses within the lens plurality 102 can be made of a material that is hard enough to withstand polishing to thereby obtain high optical quality optically-interacting surfaces. The lenses within the lens plurality 102 (as well as the aspheric toroid lens 103) can be made of, for example, fused silica, optical glass, optical ceramic, or optical crystals. The one or more lenses in the lens plurality 102 other than the aspheric toroid lens 103 can include toroid lenses such as plano-concave cylindrical lenses. The aspheric toroid lens 103 can be a single lens. The aspheric toroid lens 103 can be a plano-convex lens, a plano-concave lens, a meniscus lens with one face (the surface 101) being aspheric toroid, or a meniscus lens with both faces (the surface 101 and the surface opposite to the surface 101) being aspheric toroid. Different implementations for the lenses in the plurality 102 are discussed below.

Each of the lenses in the lens plurality 102 defines its own optical axis, which is a line that defines the optical path along which the optical beam 120 propagates through the plurality 102, to a first approximation. The optical axis passes through a center of curvature of at least one transverse axis. The optical axis can have an extent along the other transverse axis if the lenses lack curvature in the other transverse axis.

The optical mount apparatus 115 includes one or more optical mounts configured to hold or retain the lenses within the lens plurality 102. Thus, for example, the optical mount apparatus 115 can include one or more lens barrels, with a lens barrel consisting of a threaded body and a retainer ring that, when screwed together, securely hold the lens or lenses in place. Moreover, two or more lens barrels can be threaded end-to-end in the optical mount apparatus 115, depending on how many lenses need to be mounted. The optical mount apparatus 115 is held or retained by the chamber mount portion 116. The chamber mount portion 116 can be any rigid mounting element that is compatible with the material of the wall 141. For example, the chamber mount portion 116 can include one or more flexures, flexure mounts, kinematic balls, bases, plates, strain relief elements, gaskets or O-rings, and screws or other suitable connection mechanisms.

The optical beam 120 can be a continuous wave light beam, a continuous wave laser beam, a pulsed light beam, or a pulsed laser beam.

Referring to FIG. 2, an implementation 200 of the optical module 100 is a part of an illumination module 250 for the EUV light source chamber 240. The optical module 200 includes an optical mount apparatus 215 that is similar to the optical mount apparatus 115 and that holds or fixes a lens plurality 202. Like the lens plurality 102, the lens plurality 202 includes at least one aspheric toroid lens 203, with an aspheric toroid surface 201 being one of the optically-interacting surfaces of the aspheric toroid lens 203. The lens plurality 202 is placed relative to a linearly focused curtain 221 of an optical beam 220, such curtain 221 intersecting or overlapping a region of interest 235.

The optical mount apparatus 215 includes a chamber mount portion 216 configured to be fixed to a wall 241 of the EUV light source chamber 240. The chamber mount portion 216 acts as a pass-through optical pathway that defines an interior that provides an optical passage for the optical beam 220. Additionally, in these implementations, the optical path of the lens plurality 202 passes through the EUV light source chamber 240, and intersects the region of interest 235.

The illumination module 250 includes a light source 251 configured to produce the optical beam 220 and the optical module 200 is configured to pass the optical beam 220 through the wall 241 or within the EUV light source chamber 240. The optical module 200 is configured to focus the optical beam 220 as the linear curtain at the region of interest 235 inside the chamber 240. In this way, the optical path defined by the lens plurality 202 extends from the light source 251 to the region of interest 235. The illumination module 250 also includes optical components 252 that receive the optical beam 220 from the light source 251, and redirect and/or modify the optical beam 220 for input into the lens plurality 202. For example, the optical components 252 can include a fiber optic apparatus for transporting the optical beam 220 from a remote light source 251 to the chamber mount portion 216.

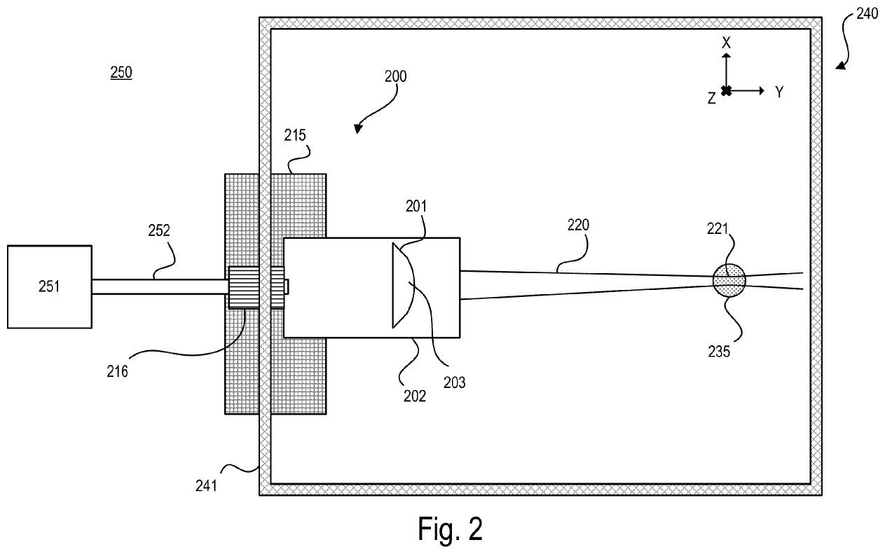

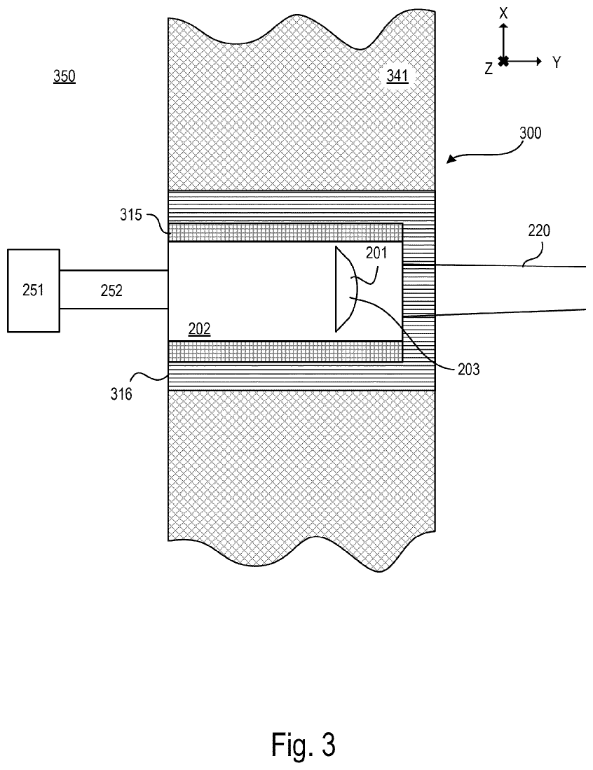

In some implementations 350 of the illumination module 250, such as shown in FIG. 3, an optical module 300 includes a chamber mount portion 316 that houses an optical mount apparatus 315 in which the lens plurality 202 is arranged. The chamber mount portion 316 is fixed within a wall 341 of the EUV light source chamber 240.

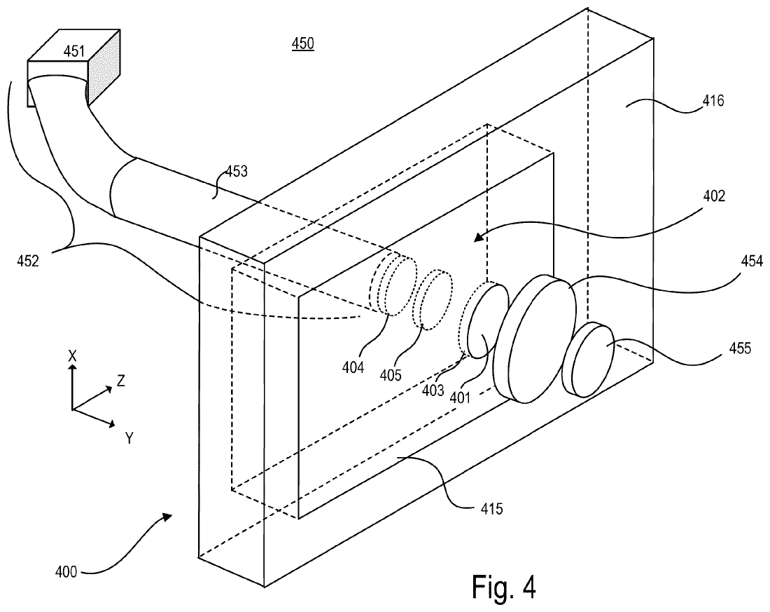

An implementation 400 of the optical module 300 and an implementation 450 of the illumination module 350 is shown in perspective view in FIG. 4. The optical module 400 includes an implementation 402 of the lens plurality 102 within an optical mount apparatus 415 that is fixed in a chamber mount portion 416. The chamber mount portion 416 is fixed to the wall 341 of the EUV light source chamber 240.

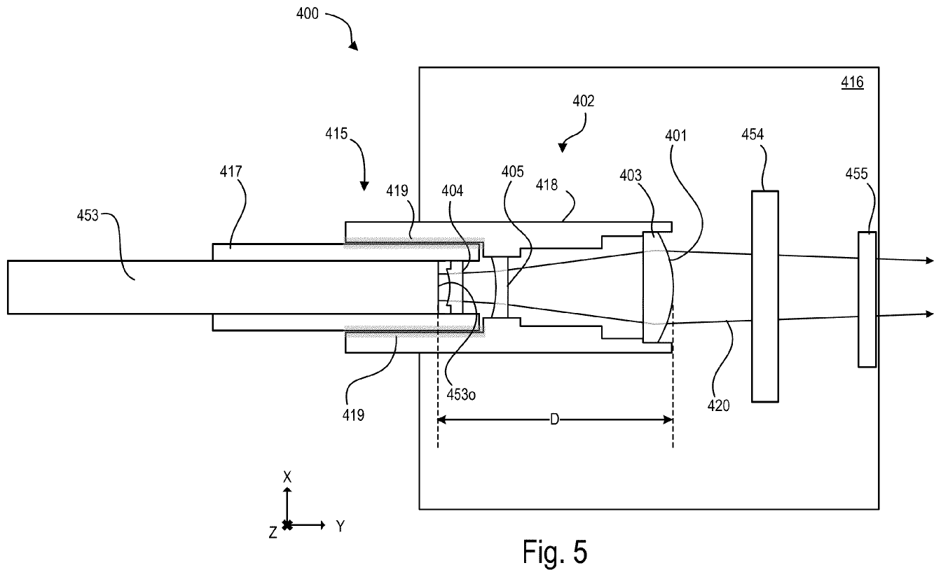

The illumination module 450 includes a remote (from the EUV light source chamber 240) light source 451 that produces the optical beam 420 (shown in FIG. 5) and optical components 452 that redirect and/or modify the optical beam 420 for input into the lens plurality 402. The optical components 452 include a portion 453 that is configured transport the optical beam 420 from the remote light source to the lens plurality 402. The portion 453 is a fiber collimator lens assembly that includes collimating optics that direct and collimate the optical beam 420 produced from the light source 451.

The lens plurality 402 includes an aspheric toroid lens 403 having an aspheric toroid surface 401. The aspheric toroid surface 401 is the closest surface and the aspheric toroid lens 401 is the closest lens of the plurality 402 to the region of interest 235 (which is not shown in FIG. 4). The lens plurality 402 also includes at least one toroid lens. In this particular implementation, the lens plurality 402 includes two toroid lenses 404, 405 arranged between the fiber collimator lens assembly 453 and the aspheric toroid lens 403. The lenses 403, 404, 405 are arranged so that their optical axes are parallel with an optical path that extends along an optical axis that is parallel with the Y axis. Because of the design of the lenses 403, 404, 405, as discussed below, the optical axes can have an extent along the Z axis.

Specifically, the optical beam 420 is focused into a line (as opposed to a point) and the line extends along the Z axis. In this particular implementation, the lenses 403, 404, 405 compress the optical beam 420 in the direction perpendicular to the line and thus the optical beam 420 is compressed along the X axis. The lenses 403, 404, 405 can leave the optical beam 420 unaltered or minimally altered in the Z direction.

In order to pass the optical beam 420 through the wall 241 of the EUV light source chamber 240, the illumination module 450 can include additional windows 454, 455 positioned within the chamber mount portion 416 and configured to seal an interior of the EUV light source chamber 240 from an exterior. The windows 454, 455 are able to withstand a pressure differential between an interior of and an exterior to the EUV light source chamber 240. The windows 454, 455 also need to be transparent to the wavelength of the optical beam 420.

FIG. 5 shows a side cross-sectional view of the optical module 400, along with the fiber collimator lens assembly 453 and the windows 454, 455. The lens plurality 402 is held by an optical mount apparatus 415. The optical mount apparatus 415 includes a pair of lens barrels 417, 418 that are coupled together at an interface 419. The interface 419 can be formed from a friction fit between an inner surface of the lens barrel 418 and an outer surface of the lens barrel 417. In this way, the lens barrels 417, 418 can be moveable relative to each other along a direction parallel with the Y axis by way of the interface 419. The lens barrel 417 holds or retains the lens 404. For example, the lens 404 can be held in place within a cavity of the lens barrel 417 by way of a retaining ring and an internal threaded body. The lens barrel 418 holds or retains the lens 405 and the aspheric toroid lens 403. Each lens 403, 405 can be held in place within a cavity of the lens barrel 418 by way of a respective retaining ring and internal threaded body. Moreover, the lens barrel 417 is configured to mate with the fiber collimator lens assembly 453. The lens barrels 417, 418 can be made from a suitable rigid material that is non-reactive to air such as stainless steel.

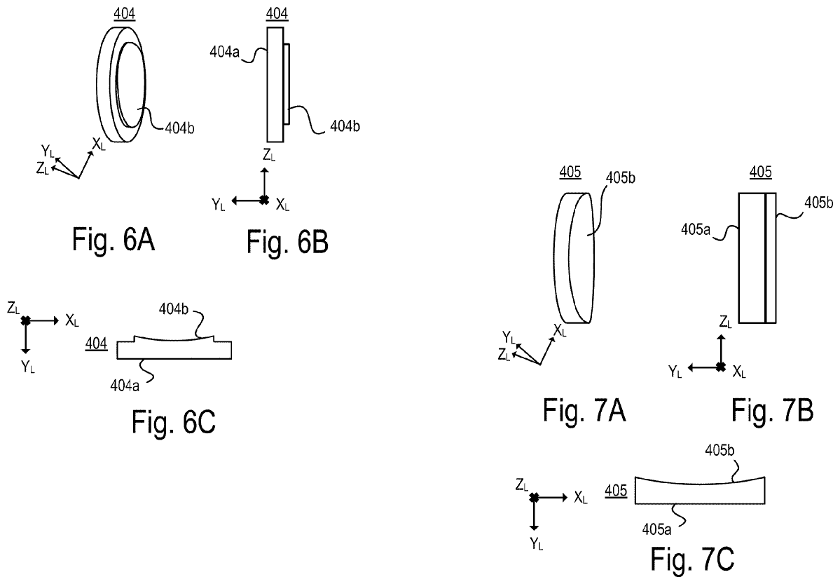

Referring to FIGS. 6A-6C, in some implementations, the toroid lens 404 is a plano-concave cylindrical lens. Specifically, the lens 404 includes a flat side (plano) 404a and a concave cylindrical side 404b opposite the plano side 404a. When placed in the lens barrel 417, and the lens barrel 417 is fixed in the chamber mount portion 416, the local optical axis Y_{L} of the lens 404 aligns with the Y axis of the EUV light source chamber 140. The concave cylindrical side 404b curves along the X_{L} axis of the lens 404 and is flat along the Z_{L} axis of the lens 404.

Referring to FIGS. 7A-7C, in some implementations, the toroid lens 405 is also a plano-concave cylindrical lens. Specifically, the lens 405 includes a flat side (plano) 405a and a concave cylindrical side 405b opposite the plano side 405a. When placed in the lens barrel 418, and the lens barrel 418 is fixed in the chamber mount portion 416, the local optical axis Y_{L} of the lens 405 aligns with the Y axis of the EUV light source chamber 140. The concave cylindrical side 405b curves along the X_{L} axis of the lens 405 and is flat along the Z_{L} axis of the lens 405.

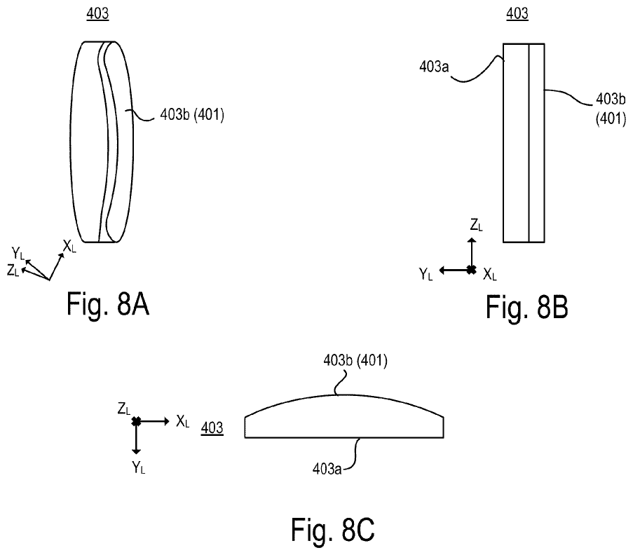

Referring to FIGS. 8A-8C, in some implementations, the aspheric toroid lens 403 is a single lens that is plano-convex. Specifically, the lens 403 includes a flat side (plano) 403a and a convex aspheric toroid side 403b (which provides the aspheric toroid surface 401) opposite the plano side 403a. When placed in the lens barrel 418, and the lens barrel 418 is fixed in the chamber mount portion 416, the local optical axis Y_{L} of the lens 403 aligns with the Y axis of the EUV light source chamber 140. The convex aspheric toroid side 403b curves along the X_{L} axis of the lens 403 and is flat along the Z_{L} axis of the lens 403.

In other implementations, the lens 403 can be plano-concave, meniscus with one face being aspheric toroid, or meniscus with both faces being aspheric toroid.

Because the plano-concave cylindrical lens 405 and the aspheric toroid lens 403 are fixed to the lens barrel 418, they are fixed in position relative to each other. Moreover, the plano-concave cylindrical lens 404 is movable relative to the pair of the plano-concave cylindrical lens 405 and the aspheric toroid lens 403 because the lens barrel 417 is movable relative to the lens barrel 418 along the Y axis (at the interface 419) and the plano-concave cylindrical lens 404 is fixed to the lens barrel 417. The adjustment between the lens barrels 417, 418 can occur during set up to adjust the position of the lens 404 relative to lenses 403, 405 to compensate for manufacturing tolerances that can vary from nominal.

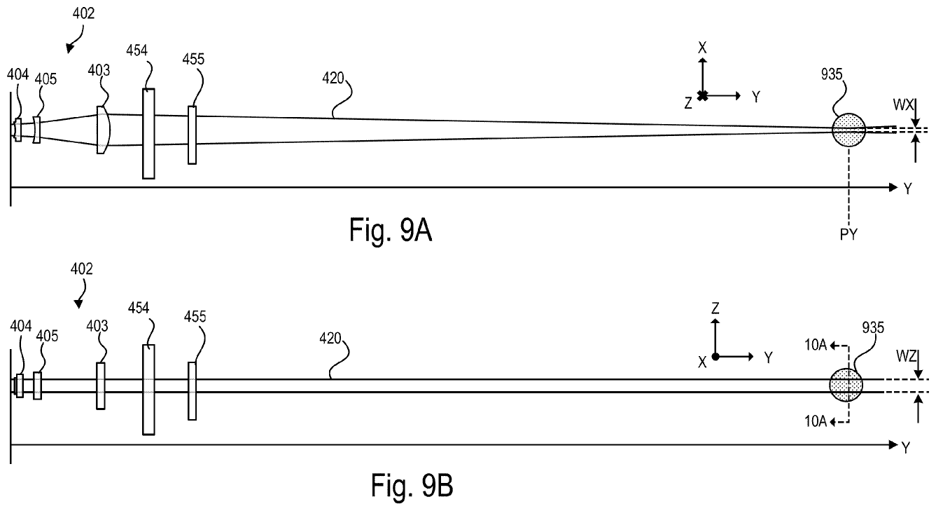

Referring to FIG. 9A, adjustment of the plano-concave cylindrical lens 404 relative to the pair of the plano-concave cylindrical lens 405 and the aspheric toroid lens 403 adjusts a position PY along the Y axis and/or a width WX along the X axis of the linearly focused curtain of the optical beam 420 at the region of interest 935. The focus sensitivity of the optical module 400 (FIG. 4) is measured by how much the width WX along the X axis changes relative to a particular adjustment to the position of the plano-concave cylindrical lens 404 relative to the pair of lenses 403, 405. The focus sensitivity of the optical module 400 can be at least 1 μm, at least 10 μm, at least 20 μm, at least 30 μm, or between 32-44 μm for an adjustment to the relative position of 1 μm. That is, the width WX changes by at least 1 μm, at least 10 μm, at least 20 μm, at least 30 μm, or between 32-44 μm for an adjustment to the relative position between the lens 404 and the pair of lenses 403, 405 of 1 μm. The optical module 400 has a focus sensitivity that is large enough (or sensitive enough) to allow the optical beam 420 to be focused as the linear curtain at the region of interest 935 using an adjustment range to the relative position of the lens 404 and the pair of lenses 403, 405 on the order of 1 μm.

Once the adjustment is completed, the lens barrels 417, 418 can then be fixed in place to thereby fix the positions of the lenses 403, 404, 405 relative to each other. Moreover, with reference to FIG. 9B, a width WZ along the Z axis of the linearly focused curtain of the optical beam 420 generally remains unchanged. In this implementation, as shown in FIGS. 9A and 9B, the linearly focused curtain of the optical beam 420 is thereby focused along the X axis of the EUV light source chamber 140. Additionally, the aspheric toroid lens 403 is the lens that is closest to the region of interest 935.

In other implementations, the linearly focused curtain of the optical beam 420 can be focused along a different axis of the EUV light source chamber 140, depending on the orientation of the lenses 403, 404, 405 relative to the EUV light source chamber 140 coordinate system. Moreover, in other implementations, the aspheric toroid lens 403 can be arranged at other locations or it may not be the lens that is closest to the region of interest 135.

In one specific implementation, the plano-concave cylindrical lens 404 has a radius of curvature (for example, along its X_{L} axis) that is 19-25 millimeters (mm); the plano-concave cylindrical lens 405 has a radius of curvature (for example, along its X_{L} axis) that is 31-39 mm; and the aspheric toroid lens 403 has a base radius of curvature (for example, along its X_{L} axis) that is 26-32 mm.

With these particular specifications, and with reference again to FIG. 5, a distance D from an adjacent mechanical output face (such as an output face 453o of the fiber collimator lens assembly 453) and the aspheric toroid surface 401 of the lens 403 can be maintained at or below 80 mm, at or below 70 mm, at or below 60 mm, or at or below 50 mm. As discussed above, the optical module 100 is designed with a significant reduction in its overall length relative to prior optical designs that pass the optical beam 120 such that the optical beam 120 is focused to the region of interest 135.

Moreover, the optical module 100 provides this space-saving reduction in length without the addition of powered optical elements such as lenses. As an example, in prior optical designs, the distance D from an output face 453o of the fiber collimator lens assembly 453 and an outer surface of the lens that is closest to the region of interest 135 is greater than 80 mm or greater than 90 mm. Moreover, the optical module 100 provides this space-saving reduction in length while still maintaining its diffraction-limited optical performance by replacing at least one of its existing toroid surfaces with the aspheric toroid surface 401 of the lens 403.

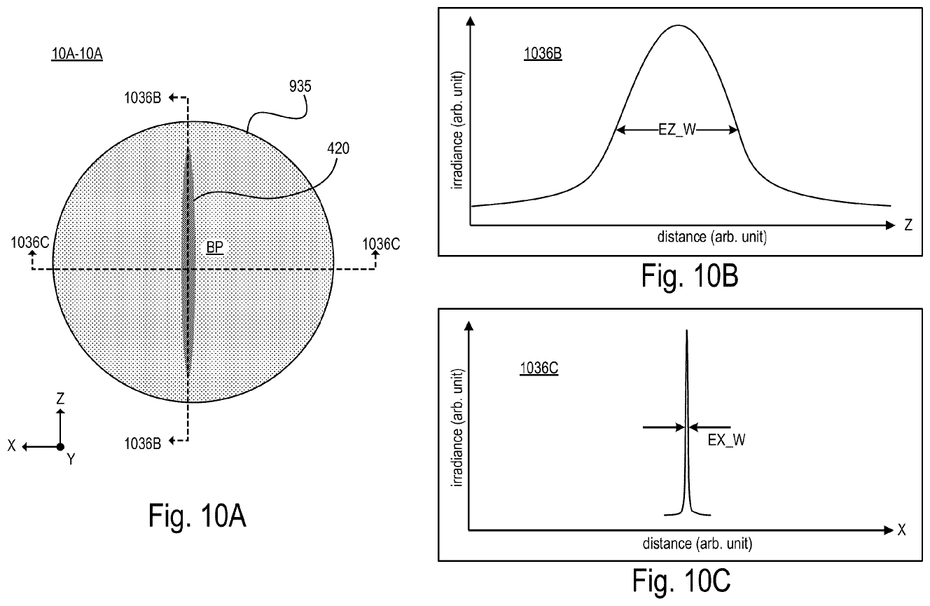

Referring again to FIGS. 9A and 9B, as discussed above, the optical beam 420 is a linearly focused curtain at the region of interest 935. Specifically, a beam profile BP of the optical beam 420 has an extent along the Z axis that is much larger than an extent along the X axis of the EUV light source chamber 140. As shown in FIG. 10A, the beam profile BP extends in the XZ plane. The beam profile BP across the Z axis is shown by the graph 1036B in FIG. 10B and the beam profile BP across the X axis is shown by the graph 1036C in FIG. 10C. The extent EZ along the Z axis (FIG. 10B) can be estimated by a width EZ_W of the graph 1036B and the extent EX along the X axis (FIG. 10C) can be estimated by a width EX_W of the graph 1036C. The widths EZ_W and EX_W can be the full width at half maximum of the respective graphs 1036B, 1036C. For example, the beam profile BP across the Z axis (given by width EZ_W) can be between 2500 micrometers (μm) and 3500 μm and the beam provide BP across the X axis (given by width EX_W) can be less than 60 μm. In general, in some implementations, the beam profile BP across the Z axis is at least 10, at least 20, at least 30, at least 40, at least 50, or at least 60 times the beam profile BP across the X axis. Thus, written in math form, EZ_W≥10×EX_W; EZ_W≥20×EX_W; EZ_W≥30×EX_W; EZ_W≥40×EX_W; EZ_W≥50×EX_W; or EZ_W≥60×EX_W.

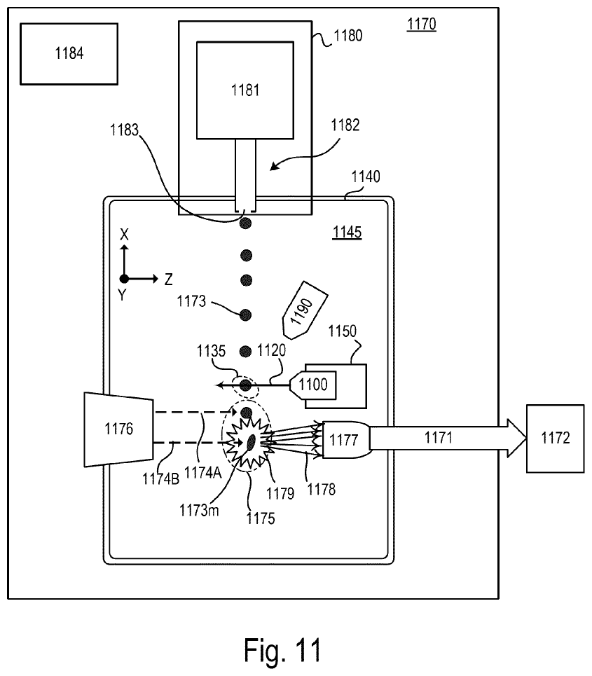

Referring to FIG. 11, an implementation 1100 of the optical module 100 is incorporated into an EUV light source 1170 that, when in operation, supplies an EUV light beam 1171 to an output apparatus 1172, which can be a lithography exposure apparatus. The EUV light source 1170 includes a vacuum chamber 1140 that defines a first target space at which each target 1173 in a stream of targets interacts with a first operational light beam 1174A to form a modified target 1173m and a second target space at which each modified target 1173m interacts with a second operational light beam 1174B. The first and second target spaces are in a target region 1175. The first and second operational light beams 1174A, 1174B are produced by an operational light source 1176.

The vacuum chamber 1140 is an implementation of the EUV light source chamber 140, and it includes a plurality of walls that together define a cavity 1145 and the target region 1175 is within the cavity 1145. Moreover, a region of interest 1135 is defined inside the cavity 1145.

In some implementations, the region of interest 1135 is a probe region through which each target 1173 passes on its way to the target region 1175. The optical module 1100 is arranged for passing an optical beam 1120 that interacts with the target 1173 in the probe region 1135 prior to the target 1173 entering the target region 1175. An illumination module 1150 includes the optical module 1100.

The EUV light source 1170 includes an EUV light collector (such as a mirror) 1177 arranged relative to the second target space. The EUV light collector 1177 collects EUV light 1178 emitted from a plasma 1179 that is produced when the modified target 1173m interacts with the second operational light beam 1174B. The EUV light collector 1177 redirects that collected EUV light 1178 as the EUV light beam 1171 toward the output apparatus 1172. The EUV light collector 1177 can be a reflective optical device such as a curved mirror that is able to reflect light having EUV wavelength (that is, the EUV light 1178) to form the produced EUV light beam 1171.

The EUV light source 1170 includes a target supply apparatus 1180 that forms a stream of the targets 1173 directed to the first target space for interaction with the first operational light beam 1174A. The targets 1173 are formed from target material that produces the EUV light 1178 when in a plasma state, such as after interaction with the second operational light beam 1174B. The second target space is, for example, a location at which the modified targets 1173m are converted to the plasma state. The target supply apparatus 1180 includes a reservoir 1181 defining a hollow interior that is configured to contain a fluid target material. The target supply apparatus 1180 includes a nozzle structure 1182 having an opening (or orifice) 1183 in fluid communication with the interior of the reservoir 1181 at one end. The target material, in a fluid state, being under the force of a pressure P (as well as other possible forces such as gravity), flows from the interior of the reservoir 1181 and through the opening 1183 to form the stream of targets 1173. The trajectory (the target axial path) of the targets 1173 that are ejected from the opening 1183 generally extends along the −X direction or axis, although it is possible for the trajectory of the targets 1173 to include components along the plane perpendicular to the −X direction (that is, Y and Z components).

Each modified target 1173m is converted at least partially or mostly to plasma through its interaction with the pulses in the second operational light beam 1174B produced by the operational light source 1176, such interaction occurring in the second target space. Each target 1173 is a target mixture that includes a target material and optionally impurities such as non-target particles. The target 1173 can be, for example, a droplet of liquid or molten metal, a portion of a liquid stream, solid particles or clusters, solid particles contained within liquid droplets, a foam of target material, or solid particles contained within a portion of a liquid stream. The target 1173 can include, for example, water, tin, lithium, xenon, or any material that, when converted to a plasma state, has an emission line in the EUV range. For example, the target 1173 can include the element tin, which can be used as pure tin (Sn); as a tin compound such as SnBr4, SnBr2, SnH4; as a tin alloy such as tin-gallium alloys, tin-indium alloys, tin-indium-gallium alloys, or any combination of these alloys.

The EUV light source 1170 can include a dedicated controller 1184 in communication with the components (such as the target supply apparatus 1180 and the operational light source 1176) of the EUV light source 1170. The controller 1184 can also communicate with the illumination module 1150 (such as the light source 251 of the illumination module 1150).

The X, Y, Z coordinate system of the EUV light source 1170 can be fixed or determined based on an aspect of the vacuum chamber 1140. For example, the chamber 1140 can be defined by a set of walls, and three points on one or more walls of the chamber 1140 or within the space of the chamber 1140 can provide reference for the X, Y, Z coordinate system. It is possible to fix one or more of the components of the illumination module 1150 to one or more walls of the chamber 1140. As discussed above, the illumination module 1150 includes the optical module 1100, which also includes a chamber mount portion (such as 116) that fixes to one or more walls of the chamber 1140).

The illumination module 1150 can function in combination with a detection module 1190, which is arranged relative to the region of interest 1135 to detect light produced due to the interaction between the optical beam 1120 and the targets 1173 in the region of interest 1135.

The implementations and/or embodiments can be further described using the following clauses:

1. An optical module for passing an optical beam, the optical module comprising:
a plurality of lenses through which the optical beam passes, the plurality of lenses including at least one aspheric toroid lens, the plurality of lenses placed relative to a linearly focused curtain of the optical beam, the linearly focused curtain intersecting a region of interest; and
an optical mount apparatus in which the plurality of lenses is mounted, wherein the optical mount apparatus is arranged in or fixed to a wall of a chamber of an extreme ultraviolet (EUV) light source such that an optical path is defined that passes through the EUV light source chamber and intersects the region of interest inside the chamber.

2. The optical module of clause 1, wherein the plurality of lenses comprises at least one toroid lens.

3. The optical module of clause 2, wherein:
the at least one toroid lens comprises a first plano-concave cylindrical lens and a second plano-concave cylindrical lens; and
the at least one aspheric toroid lens is a single lens that is plano-convex, plano-concave, meniscus with one face being aspheric toroid, or meniscus with both faces being aspheric toroid.

4. The optical module of clause 3, wherein the second plano-concave cylindrical lens and the aspheric toroid lens are fixed in position relative to each other and moveable together relative to the first plano-concave cylindrical lens.

5. The optical module of clause 4, wherein adjustment of the first plano-concave cylindrical lens relative to the second plano-concave cylindrical lens and the aspheric toroid lens adjusts a position and/or a width of the linearly focused curtain.

6. The optical module of clause 3, wherein:
the linearly focused curtain of the optical beam is focused along an axis of the chamber;
the first plano-concave cylindrical lens has a radius of curvature along the axis that is −19 mm to −25 mm;
the second plano-concave cylindrical lens has a radius of curvature along the axis that is −31 mm to −39 mm; and
the aspheric toroid lens has a base radius of curvature along the axis that is −26 mm to −32 mm.

7. The optical module of clause 6, wherein the distance from an adjacent mechanical output face and an outer face of the aspheric toroid lens is less than 80 millimeters (mm), less than 70 mm, less than 60 mm, or less than 50 mm.

8. The optical module of clause 7, wherein the adjacent mechanical output face is an output face of an optical collimator.

9. The optical module of clause 1, wherein the linearly focused curtain is formed from the optical beam passing through the plurality of lenses and to the region of interest inside the chamber.

10. The optical module of clause 1, wherein the aspheric toroid lens is the lens that is closest to the region of interest.

11. The optical module of clause 1, wherein the at least one aspheric toroid lens is a single lens that is plano-convex, plano-concave, meniscus with one face being aspheric toroid, or meniscus with both faces being aspheric toroid.

12. The optical module of clause 1, wherein the aspheric toroid lens is an acylindrical lens.

13. The optical module of clause 1, wherein the plurality of lenses is configured and arranged to thereby reduce optical aberrations such that their actual resolution is diffraction limited.

14. The optical module of clause 1, wherein the optical beam travels along an optical axis of the chamber, and the linearly focused curtain of the optical beam has a beam profile along a first axis perpendicular to the optical axis of the chamber that is at least 10, at least 20, at least 30, at least 40, at least 50, or at least 60 times a beam profile along the a second axis perpendicular to the optical of the chamber within the region of interest inside the chamber.

15. The optical module of clause 1, wherein the optical mount apparatus is arranged in a wall of the EUV light source chamber.

16. The optical module of clause 15, wherein the optical path passes through an optically-transparent window fixed within the chamber wall.

17. An illumination module for an extreme ultraviolet (EUV) light source, the illumination module comprising:
a light source configured to produce an optical beam; and
an optical module configured to pass the optical beam through a wall of or within a chamber of the EUV light source and to focus the optical beam as a linear curtain at a region of interest inside the chamber, the optical module comprising a plurality of lenses through which the optical beam passes and defining an optical path from the light source to the region of interest, the plurality of lenses including at least one aspheric toroid lens.

18. The illumination module of clause 17, wherein the plurality of lenses comprises at least one toroid lens.

19. The illumination module of clause 18, wherein:
the at least one toroid lens comprises a first plano-concave cylindrical lens and a second plano-concave cylindrical lens; and
the at least one aspheric toroid lens is a single lens that is plano-convex, plano-concave, meniscus with one face being aspheric toroid, or meniscus with both faces being aspheric toroid.

20. The illumination module of clause 19, wherein the second plano-concave cylindrical lens and the aspheric toroid lens are fixed in position relative to each other and moveable together relative to the first plano-concave cylindrical lens.

21. The illumination module of clause 20, wherein adjustment of the first plano-concave cylindrical lens relative to the second plano-concave cylindrical lens and the aspheric toroid lens adjusts a position and/or a width of the linearly focused curtain in the region of the interest.

22. The illumination module of clause 21, wherein the optical module has a focus sensitivity of at least 1 μm, at least 10 μm, at least 20 μm, at least 30 μm, or between 32 to 44 μm per adjustment of the first plano-concave cylindrical lens relative to the second plano-concave cylindrical lens and the aspheric toroid lens of 1 μm.

23. The illumination module of clause 21, wherein the optical module has a focus sensitivity that is sensitive enough to allow the optical beam to be focused as the linear curtain at the region of interest inside the chamber using an adjustment range on the order of a micron.

24. The illumination module of clause 19, wherein:
the linearly focused curtain of the optical beam is focused along an axis of the chamber;
the first plano-concave cylindrical lens has a radius of curvature along the axis that is −19 mm to −25 mm;
the second plano-concave cylindrical lens has a radius of curvature along the axis that is −31 mm to −39 mm; and
the aspheric toroid lens has a base radius of curvature along the axis that is −26 mm to −32 mm.

25. The illumination module of clause 24, wherein the distance from an adjacent mechanical output face and an outer face of the aspheric toroid lens is less than 80 millimeters (mm), less than 70 mm, less than 60 mm, or less than 50 mm.

26. The illumination module of clause 25, wherein the adjacent mechanical output face is an output face of an optical collimator.

27. The illumination module of clause 17, wherein the aspheric toroid lens is the lens that is closest to the region of interest.

28. The illumination module of clause 17, wherein the aspheric toroid lens is an acylindrical lens.

29. The illumination module of clause 17, wherein the optical beam travels along an optical axis of the chamber, and the linearly focused curtain of the optical beam has a beam profile along a first axis perpendicular to the optical axis of the chamber that is at least 10, at least 20, at least 30, at least 40, at least 50, or at least 60 times a beam profile along a second axis perpendicular to the optical axis of the chamber within the region of interest inside the chamber.

30. The illumination module of clause 17, wherein the optical beam is a continuous wave light beam.

31. The illumination module of clause 17, wherein each of the lenses is made of fused silica, optical glass, optical ceramic, or optical crystals.

32. An extreme ultraviolet (EUV) light source comprising:
a chamber comprising a plurality of walls that together define a cavity, wherein a region of interest is defined inside the cavity; and
an optical module for passing an optical beam, the optical module comprising:
a plurality of lenses through which the optical beam passes, the plurality of lenses including at least one aspheric toroid lens, the plurality of lenses placed relative to a linearly focused curtain of the optical beam, the linearly focused curtain intersecting a region of interest; and
an optical mount apparatus in which the plurality of lenses is mounted, wherein the optical mount apparatus is arranged in or fixed to a wall of a chamber such that an optical path is defined that intersects the region of interest inside the chamber.

33. The EUV light source of clause 32, wherein the plurality of lenses comprises at least one toroid lens.

34. The EUV light source of clause 32, further comprising an illumination module comprising a light source configured to produce the optical beam and the optical module configured to receive the produced optical beam from the light source.

Other implementations are within the scope of the claims.

1. An optical module for passing an optical beam, the optical module comprising:
a plurality of lenses through which the optical beam passes, the plurality of lenses including at least one aspheric toroid lens, the plurality of lenses placed relative to a linearly focused curtain of the optical beam, the linearly focused curtain intersecting a region of interest; and
an optical mount apparatus in which the plurality of lenses is mounted, wherein the optical mount apparatus is arranged in or fixed to a wall of a chamber of an extreme ultraviolet (EUV) light source such that an optical path is defined that passes through the EUV light source chamber and intersects the region of interest inside the chamber.

2. The optical module of claim 1, wherein the plurality of lenses comprises at least one toroid lens.

3. (canceled)

4. The optical module of claim 2, wherein:
the at least one toroid lens comprises a first plano-concave cylindrical lens and a second plano-concave cylindrical lens;
the at least one aspheric toroid lens is a single lens that is plano-convex, plano-concave, meniscus with one face being aspheric toroid, or meniscus with both faces being aspheric toroid; and
wherein the second plano-concave cylindrical lens and the aspheric toroid lens are fixed in position relative to each other and moveable together relative to the first plano-concave cylindrical lens.

5. (canceled)

6. The optical module of claim 2, wherein:
the at least one toroid lens comprises a first plano-concave cylindrical lens and a second plano-concave cylindrical lens;
the at least one aspheric toroid lens is a single lens that is plano-convex, plano-concave, meniscus with one face being aspheric toroid, or meniscus with both faces being aspheric toroid;
the linearly focused curtain of the optical beam is focused along an axis of the chamber;
the first plano-concave cylindrical lens has a radius of curvature along the axis that is −19 mm to −25 mm;
the second plano-concave cylindrical lens has a radius of curvature along the axis that is −31 mm to −39 mm; and
the aspheric toroid lens has a base radius of curvature along the axis that is −26 mm to −32 mm.

7. (canceled)

8. (canceled)

9. The optical module of claim 1, wherein the linearly focused curtain is formed from the optical beam passing through the plurality of lenses and to the region of interest inside the chamber.

10. The optical module of claim 1, wherein the aspheric toroid lens is the lens that is closest to the region of interest.

11. The optical module of claim 1, wherein the at least one aspheric toroid lens is a single lens that is plano-convex, plano-concave, meniscus with one face being aspheric toroid, or meniscus with both faces being aspheric toroid.

12. The optical module of claim 1, wherein the aspheric toroid lens is an acylindrical lens.

13. The optical module of claim 1, wherein the plurality of lenses is configured and arranged to thereby reduce optical aberrations such that their actual resolution is diffraction limited.

14. The optical module of claim 1, wherein the optical beam travels along an optical axis of the chamber, and the linearly focused curtain of the optical beam has a beam profile along a first axis perpendicular to the optical axis of the chamber that is at least 10, at least 20, at least 30, at least 40, at least 50, or at least 60 times a beam profile along the a second axis perpendicular to the optical of the chamber within the region of interest inside the chamber.

15. (canceled)

16. The optical module of claim 1, wherein the optical mount apparatus is arranged in a wall of the EUV light source chamber; and
wherein the optical path passes through an optically-transparent window fixed within the chamber wall.

17. An illumination module for an extreme ultraviolet (EUV) light source, the illumination module comprising:
a light source configured to produce an optical beam; and
an optical module configured to pass the optical beam through a wall of or within a chamber of the EUV light source and to focus the optical beam as a linear curtain at a region of interest inside the chamber, the optical module comprising a plurality of lenses through which the optical beam passes and defining an optical path from the light source to the region of interest, the plurality of lenses including at least one aspheric toroid lens.

18. The illumination module of claim 17, wherein the plurality of lenses comprises at least one toroid lens.

19. (canceled)

20. The illumination module of claim 18, wherein:
the at least one toroid lens comprises a first plano-concave cylindrical lens and a second plano-concave cylindrical lens;
the at least one aspheric toroid lens is a single lens that is plano-convex, plano-concave, meniscus with one face being aspheric toroid, or meniscus with both faces being aspheric toroid; and
wherein the second plano-concave cylindrical lens and the aspheric toroid lens are fixed in position relative to each other and moveable together relative to the first plano-concave cylindrical lens.

21.-26. (canceled)

27. The illumination module of claim 17, wherein the aspheric toroid lens is the lens that is closest to the region of interest.

28. The illumination module of claim 17, wherein the aspheric toroid lens is an acylindrical lens.

29. The illumination module of claim 17, wherein the optical beam travels along an optical axis of the chamber, and the linearly focused curtain of the optical beam has a beam profile along a first axis perpendicular to the optical axis of the chamber that is at least 10, at least 20, at least 30, at least 40, at least 50, or at least 60 times a beam profile along a second axis perpendicular to the optical axis of the chamber within the region of interest inside the chamber.

30. The illumination module of claim 17, wherein the optical beam is a continuous wave light beam.

31. (canceled)

32. An extreme ultraviolet (EUV) light source comprising:
a chamber comprising a plurality of walls that together define a cavity, wherein a region of interest is defined inside the cavity; and
an optical module for passing an optical beam, the optical module comprising:
a plurality of lenses through which the optical beam passes, the plurality of lenses including at least one aspheric toroid lens, the plurality of lenses placed relative to a linearly focused curtain of the optical beam, the linearly focused curtain intersecting a region of interest; and
an optical mount apparatus in which the plurality of lenses is mounted, wherein the optical mount apparatus is arranged in or fixed to a wall of a chamber such that an optical path is defined that intersects the region of interest inside the chamber.

33. The EUV light source of claim 32, wherein the plurality of lenses comprises at least one toroid lens.

34. The EUV light source of claim 32, further comprising an illumination module comprising a light source configured to produce the optical beam and the optical module configured to receive the produced optical beam from the light source.
